(19) United States
(12) Patent Application Publication
(10) Pub. No.: US 2017/0164757 A1
(43) Pub. Date: Jun. 15, 2017

(54) METHODS AND SYSTEMS FOR HEATING AND COOLING SEATS AND OTHER USER ITEMS UTILIZING THERMALLY CONDUCTIVE SHEET WITH ONE OR MORE THERMOELECTRIC DEVICES

(71) Applicant: Novus Energy Technologies, Inc., Raleigh, NC (US)

(72) Inventors: Peter M. Thomas, Raleigh, NC (US); Stephen M. Thomas, Raliegh, NC (US)

(21) Appl. No.: 15/291,239

(22) Filed: Oct. 12, 2016

Related U.S. Application Data
(60) Provisional application No. 62/240,411, filed on Oct. 12, 2015.

(51) Int. Cl. A47C 21/04; A47C 7/74; A47C 7/02; F25B 21/04; B60N 2/56

(52) U.S. Cl. CPC A47C 21/04; F25B 21/04; B60N 2/5642; B60N 2/5657; B60N 2/5678; B60N 2/5692; A47C 7/021; A47C 7/74

(57) ABSTRACT

A cooling and heating system for seats and other user items utilizes a thermally conductive sheet with one or more thermoelectric devices. This thermally conductive sheet has high thermal conductivity and is flexible, and may comprise polyimide, graphite, PGS graphite, carbon fiber, or more advanced materials such as graphene or carbon nanotubes or other high thermal conductivity material such as copper or aluminum sheet or mesh. The thermally conductive flexible sheet with remote thermoelectric device provides good temperature uniformity across the seat, quick response time, and excellent performance in extreme ambient temperatures. The high thermal conductivity sheet can be placed in the seat area between the upholstery and seat cushion with thermoelectric devices thermally connected to the thermally conductive sheet away from the occupant seating area to provide comfortable and durable seating with thermal comfort control. Heat rejection may be accomplished using a heat sink (with or without a fan) or a heat pipe connected to a heat sink (with or without a fan) or other heat rejection mechanisms.

### CROSS REFERENCE TO RELATED APPLICATION

This application claims priority from U.S. Provisional Patent Application No. 62/240,411 filed on Oct. 12, 2015 entitled SEAT COOLING AND HEATING UTILIZING A THERMALLY CONDUCTIVE SHEET WITH THERMOELECTRIC DEVICE(S), which is hereby incorporated by reference.

### BACKGROUND

The present application generally relates to methods and systems for heating and cooling seats and other user items using thermally conductive sheets and thermoelectric devices.

A number of problems exist with current techniques for heating and cooling car seats and other user items. For example, current car seat cooling technology, which can use a blower in combination with thermoelectric devices and duct work to deliver cool air through holes in the leather upholstery of the seat cushion, generally does not work well on hot days or in hot climates. The seat cooling systems generally have only a small cooling area, slow response, and poor cooling performance. Cooling performance worsens when the occupant is seated since the holes in the upholstery are obstructed by the clothing of the occupant. For seat manufacturers, the current seat cooling technology can be expensive, require undesirable perforations in leather, cloth, or other upholstery, and can be difficult and costly to install.

A need exists for improved methods and systems for heating and cooling seats and other user items.

### BRIEF SUMMARY OF THE DISCLOSURE

A device in accordance with one or more embodiments includes an article for use by a user and a heating and/or cooling system arranged with the article to heat and/or cool the user. The heating and/or cooling system includes a flexible thermally conductive sheet positioned in the article to be proximate to the user, one or more thermoelectric modules or heat pumps in thermal contact with the flexible thermally conductive sheet, and a heat rejection system in thermal contact with the one or more thermoelectric modules or heat pumps. The one or more thermoelectric modules or heat pumps can be powered to pump heat from the flexible thermally conductive sheet to the heat rejection system in a cooling mode and/or pump heat from the heat rejection/absorbtion system to the flexible thermally conductive sheet in a heating mode.

### BRIEF DESCRIPTION OF THE DRAWINGS

FIG. 1 schematically illustrates an exemplary car seat including a heating and cooling system having a single thermoelectric device in accordance with one or more embodiments.

FIG. 2 schematically illustrates another exemplary car seat including a heating and cooling system having a single thermoelectric device in accordance with one or more embodiments.

FIG. 3 schematically illustrates an exemplary car seat including a heating and cooling system having two or more thermoelectric devices in accordance with one or more embodiments.

FIG. 4 schematically illustrates an exemplary car seatback including a heating and cooling system having a single thermoelectric device in accordance with one or more embodiments.

FIG. 5 schematically illustrates an exemplary car seatback including a heating and cooling system having a remotely located single thermoelectric device at the top of the seatback in accordance with one or more embodiments.

FIG. 6 schematically illustrates an exemplary car seatback including a heating and cooling system having a remotely located single thermoelectric device at the bottom of the seatback in accordance with one or more embodiments.

FIG. 7 schematically illustrates an exemplary car seatback including a heating and cooling system having a single thermoelectric device in accordance with one or more embodiments.

FIG. 8 schematically illustrates an exemplary car seatback including a heating and cooling system having a single thermoelectric device in accordance with one or more embodiments.

FIG. 9 schematically illustrates an exemplary car seatback including a heating and cooling system having two or more thermoelectric devices in accordance with one or more embodiments.

FIGS. 10A-10D schematically illustrate top, back, bottom, and top views, respectively, of an exemplary seat cushion in accordance with one or more embodiments.

FIGS. 11A-11D schematically illustrate top, back, bottom, and top views, respectively, of another exemplary seat cushion in accordance with one or more embodiments.

FIG. 12 is a cross-section view schematically illustrating an exemplary graphite foam block heat exchanger of a heating and cooling system in accordance with one or more embodiments.

FIG. 13 is a cross-section view schematically illustrating an exemplary car seat bottom including a heating and cooling system in accordance with one or more embodiments.

FIG. 14 is a cross-section view schematically illustrating an exemplary car seat bottom including a heating and cooling system in accordance with one or more embodiments.

Like reference numerals indicate the same or similar elements throughout the drawings.

### DETAILED DESCRIPTION

Various embodiments disclosed herein are directed to methods and systems for heating and cooling seats and other user items utilizing a flexible thermally conductive sheet actively cooled or heated by one or more separate thermoelectric devices or heat pumps.

The heating and cooling systems can be used in a variety of user items including, but not limited to, vehicle seats and other seats, chairs, beds, cooling or heating pads, and apparel such as vests and coats, to provide efficient and effective heating and/or cooling of the user.

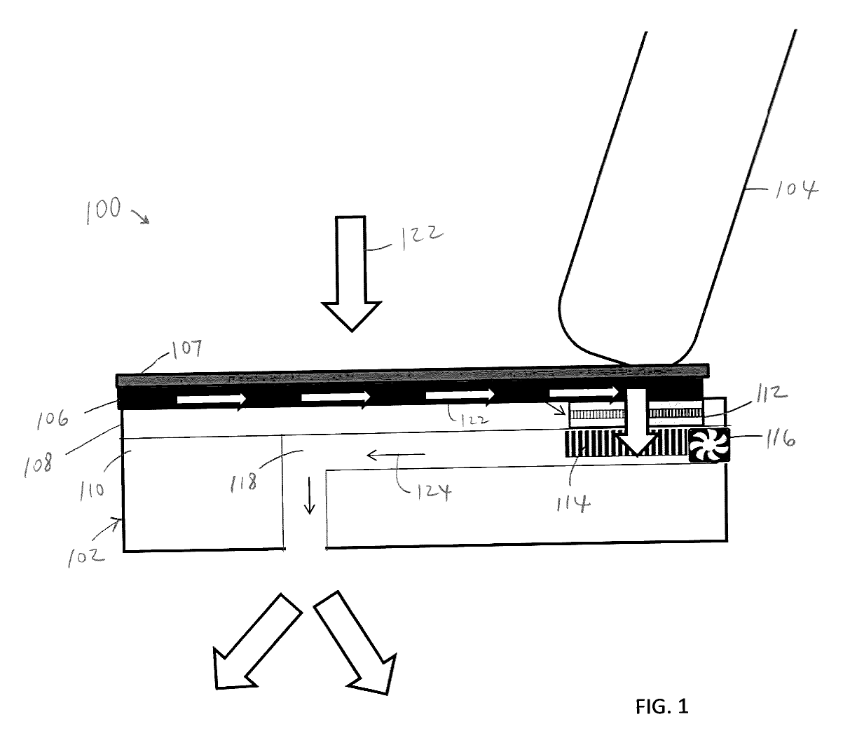

FIG. 1 schematically illustrates an exemplary car seat 100 including a heating and cooling system in accordance with one or more embodiments. The car seat 100 includes a seat bottom 102 and a seat back 104. A flexible thermally conductive graphite sheet 106 is provided on the seat bottom 102 proximate to a seated user. Upholstery 107 covers the graphite sheet 106. An optional low thermal conductivity insulation material 108 is positioned between the graphite sheet 106 and the bottom seat cushion 110. Since the seat cushion is typically made of insulating materials, the low conductivity insulation material is typically not necessary. A thermoelectric device 112 is thermally coupled at its top side to the graphite sheet 106. The bottom side of the thermoelectric device 112 is attached to a heat rejection system comprising a heat sink 114 and a fan or blower 116. The fan/blower blows air from the heat sink through an air flow channel 118 in the bottom seat cushion 110, and out of bottom of the seat. Arrows 122 indicate heat flow and arrows 124 indicate airflow.

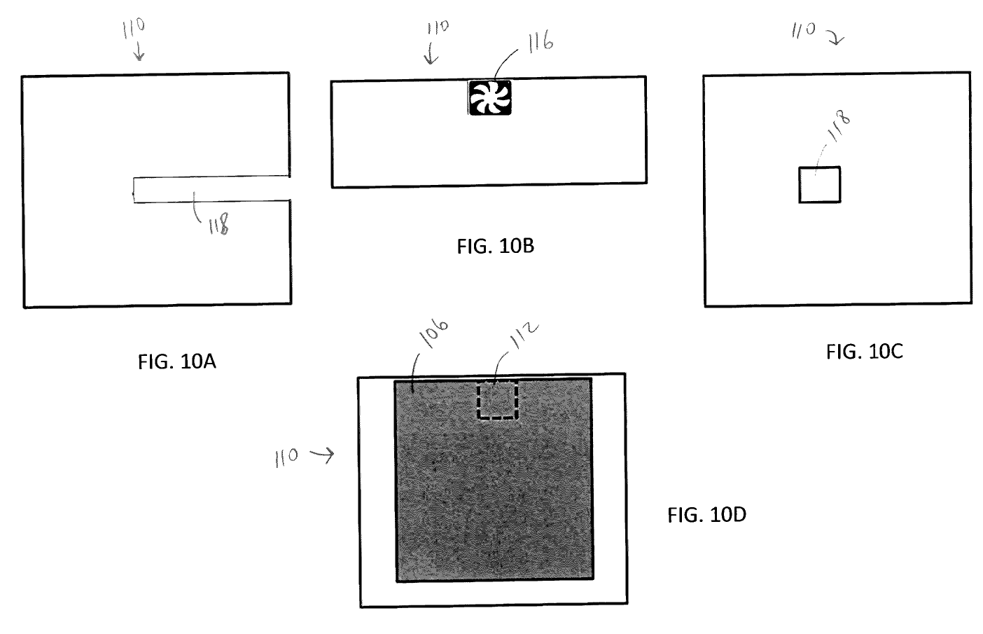

FIGS. 10A-10D schematically illustrate top, back, bottom, and top views, respectively, of the seat cushion 110 of FIG. 1.

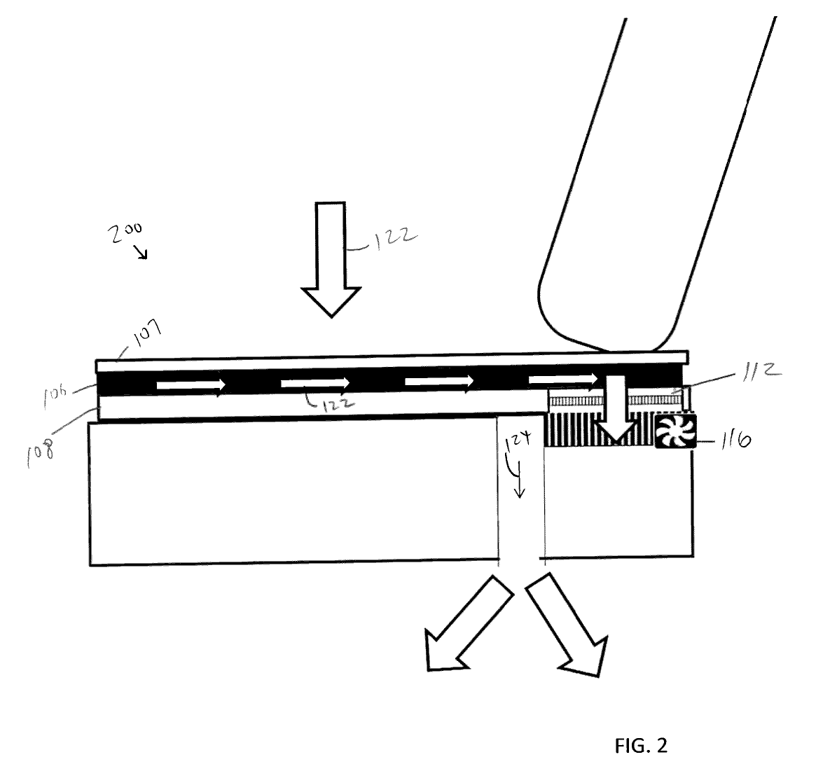

FIG. 2 schematically illustrates another exemplary car seat 200 in accordance with one or more embodiments having a different air flow channel configuration from the car seat of FIG. 1.

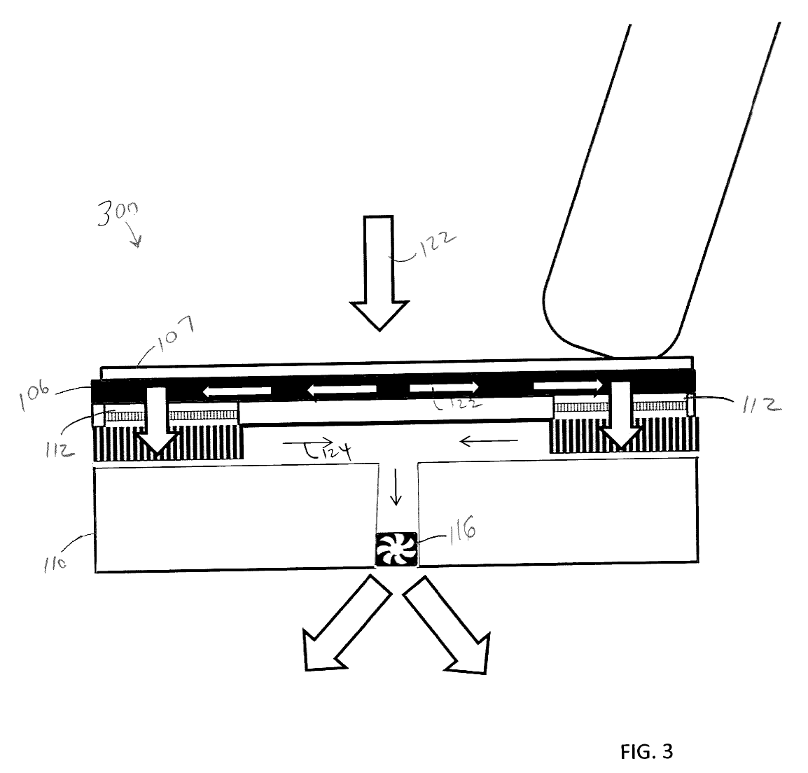

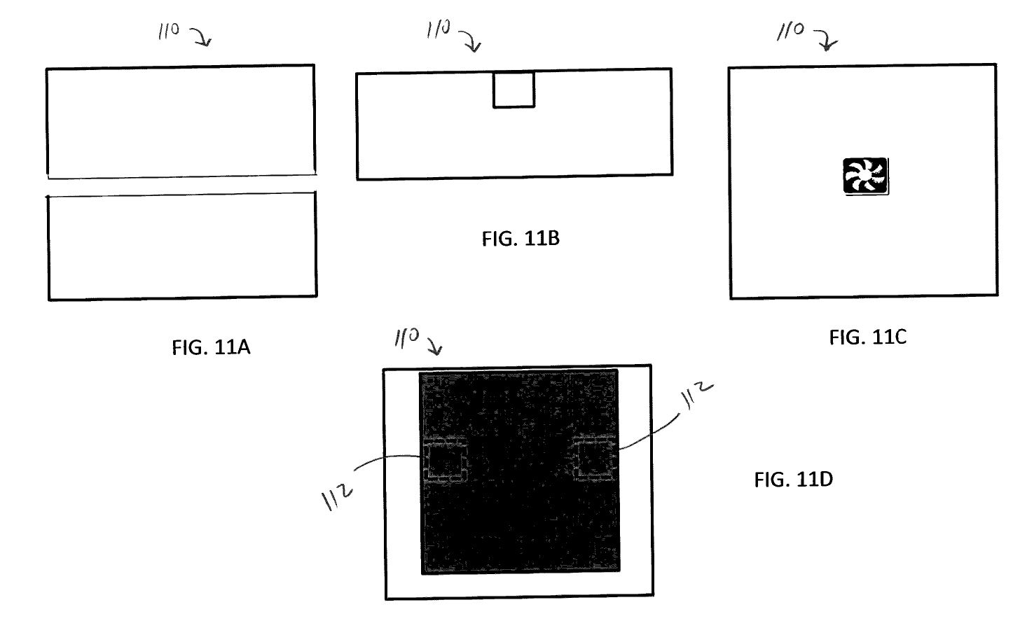

FIG. 3 schematically illustrates an exemplary car seat 300 including a heating and cooling system having two or more thermoelectric devices 112 in accordance with one or more embodiments. FIGS. 11A-11D schematically illustrate top, back, bottom, and top views, respectively, of the seat cushion 110 of FIG. 3.

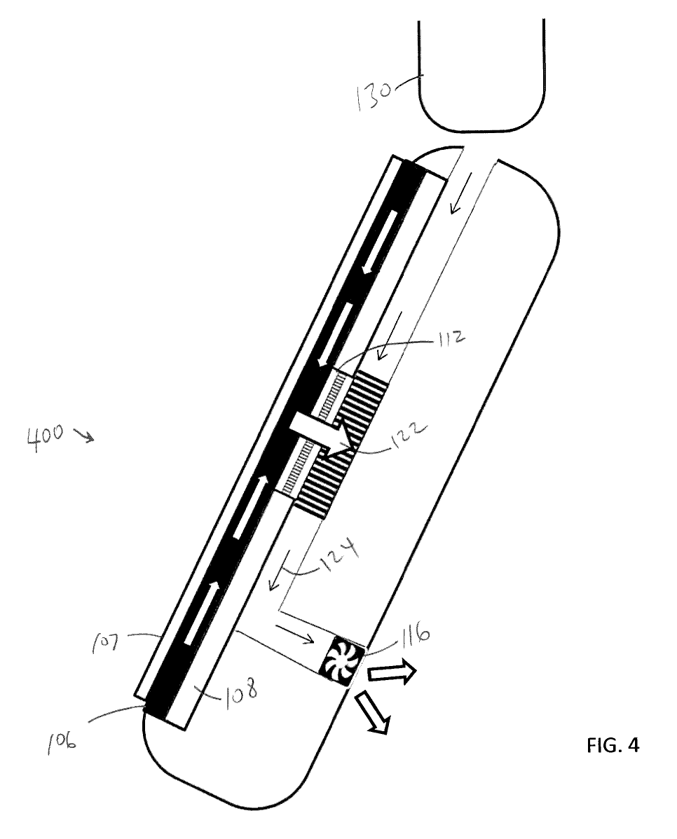

FIG. 4 schematically illustrates an exemplary car seatback 400 including a heating and cooling system having a single thermoelectric device 112 in accordance with one or more embodiments. A head rest 130 is mounted on the seatback 400.

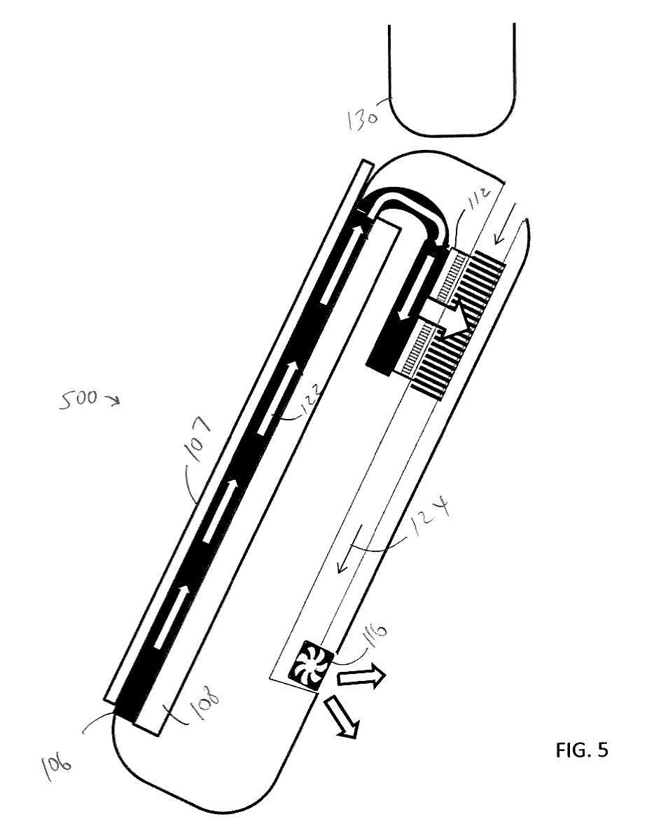

FIG. 5 schematically illustrates an exemplary car seatback 500 including a heating and cooling system having a remotely located single thermoelectric device 112 in accordance with one or more embodiments.

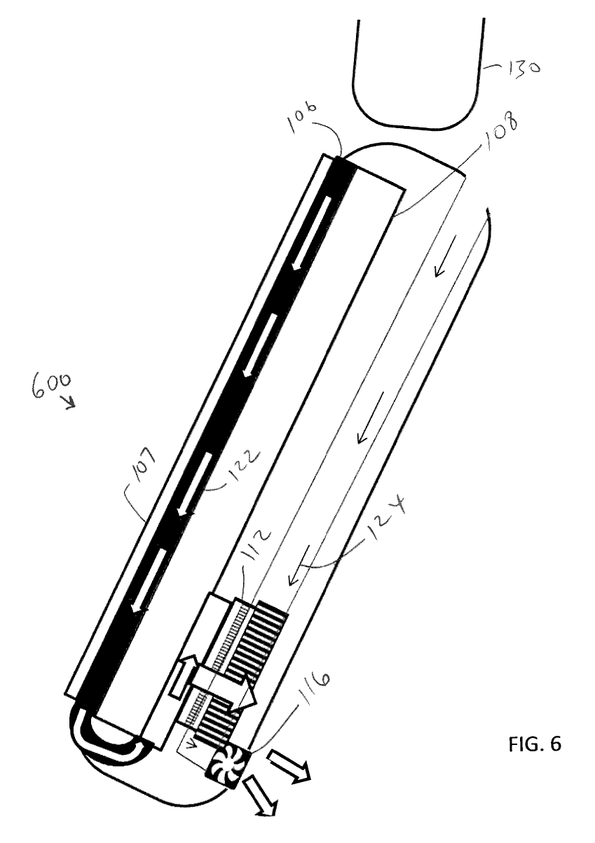

FIG. 6 schematically illustrates an exemplary car seatback 600 including a heating and cooling system having a remotely located single thermoelectric device 112 at the bottom of the seatback in accordance with one or more embodiments.

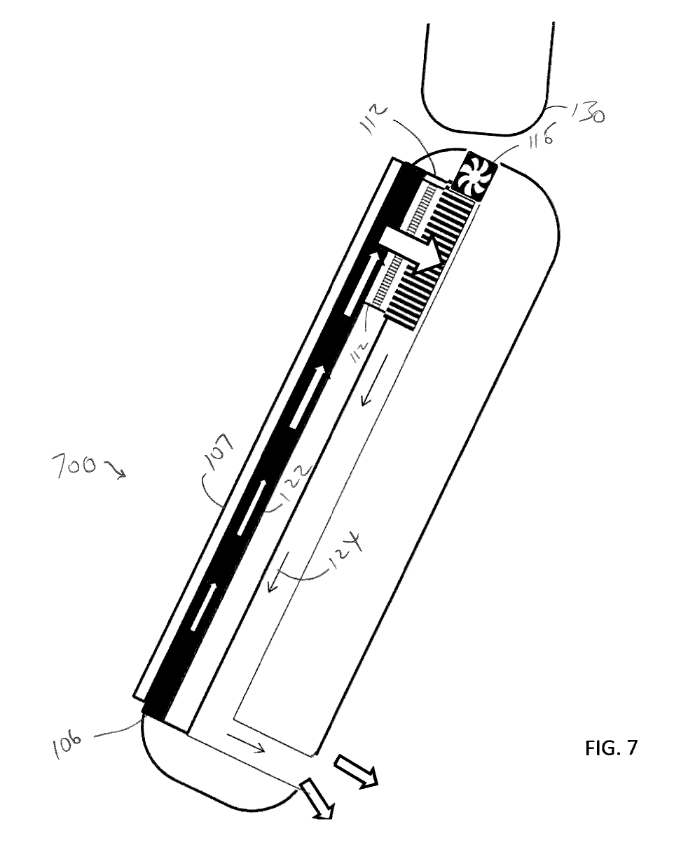

FIG. 7 schematically illustrates an exemplary car seatback 700 including a heating and cooling system having a single thermoelectric device 112 in accordance with one or more embodiments.

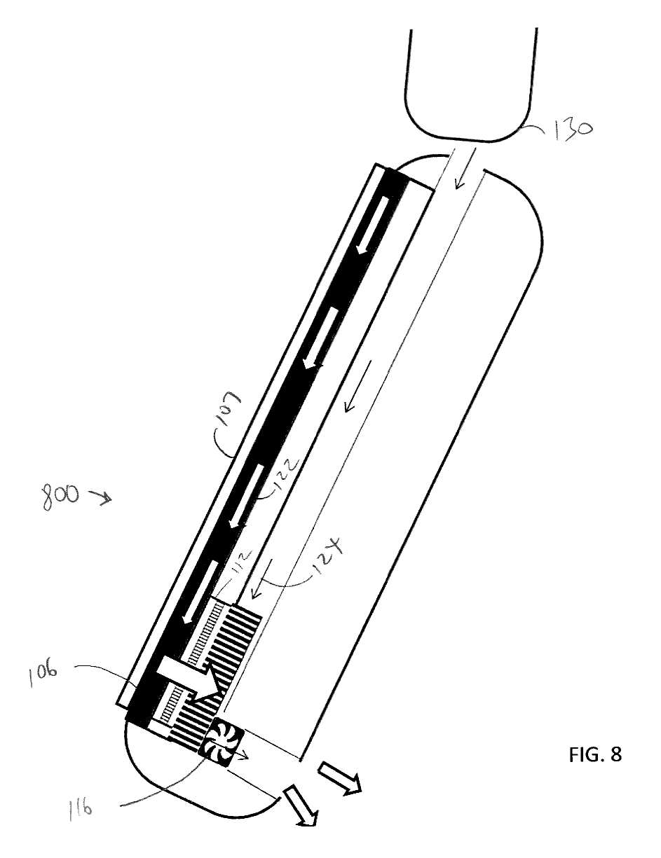

FIG. 8 schematically illustrates an exemplary car seatback 800 including a heating and cooling system having a single thermoelectric device 112 in accordance with one or more embodiments.

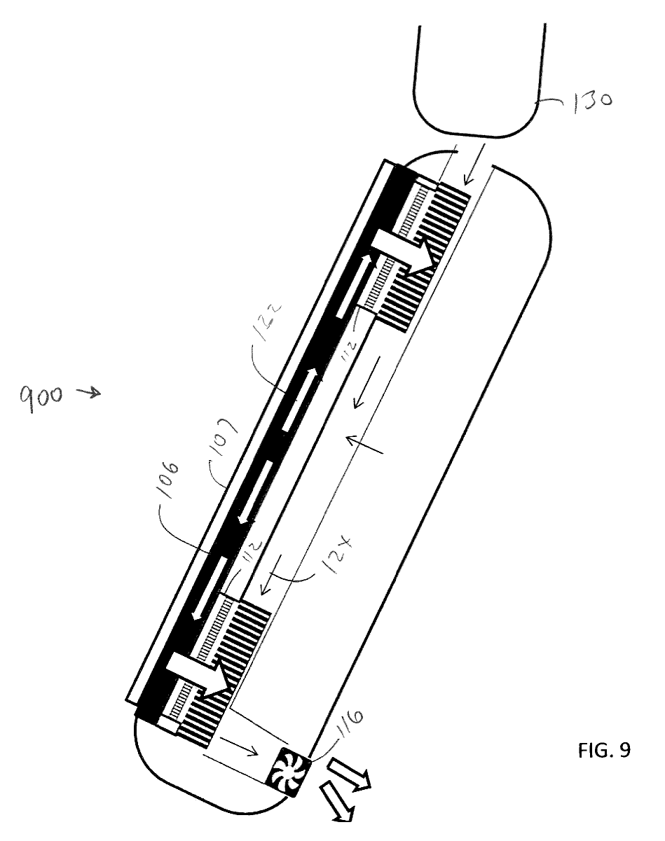

FIG. 9 schematically illustrates an exemplary car seatback 900 including a heating and cooling system having two or more thermoelectric devices 112 in accordance with one or more embodiments.

The flexible thermally conductive sheet in the heating and cooling system has high thermal conductivity (e.g., greater than 100 W/m-K), which insures good temperature uniformity across the seat or other user item. In seat embodiments, the system includes a high thermal conductivity sheet in the seat cushion area. The thermoelectric devices, which are typically rigid, are thermally coupled to the thermally conductive sheet and positioned away from the seat cushion area to provide comfortable seating. The thermoelectric devices can be attached to the thermally conductive sheet at the edges of the seat or underneath the seat so they do not affect the comfort or durability of the seat and the cooling and heating system.

Heating and cooling systems in accordance with various embodiments have several advantages over the prior art. They provide a large surface area for cooling and heating, effective cooling on hot days and in hot climates, and a fast response (e.g., only a few seconds) to provide effective cooling.

In the seat embodiment, the thermally conductive sheet cooled or heated by thermoelectric devices is put in direct contact with the seat cover upholstery. This enables direct cooling or heating of the person sitting in the seat, unlike many prior art systems that provide forced air cooling and heating though using a convective blower. Such systems have a thermoelectric device mounted at the end of the blower, which is used to cool air going through a duct to the seat cushion. The leather, cloth, or other upholstery on the seat cushion in such systems is perforated to allow the cool air to flow to and cool the occupant. The cooling and heating can take a long time because the air has to cool down or heat up and then convectively transport the cooling or heating effect to the seat upholstery and occupant, which can often take 10 minutes or more to occur. Heating and cooling systems in accordance with various embodiments use a flexible thermally conductive sheet with thermoelectric devices for direct contact cooling or heating of the occupant. The large format thermally conductive sheet with thermoelectric devices can be made to generally any size and configured to cool or heat a large area of the seat cushion. Direct contact cooling and heating has only a few seconds time lag from when the power is turned on. Since air convection is a poor transporter of heat and because there are delta temperature losses associated with both the thermoelectric to air and the air to the seat thermal conduction the prior technology has poor cooling performance on hot days or in hot climates. Heating and cooling systems in accordance with various embodiments use of direct cooling can provide significantly improved cooling performance on hot days. For instance, it is possible to obtain a high delta T, e.g., 30° C. (60° F.) with direct cooling so that if the cabin temperature is 130° F. then the seat temperature will be 70° F. within a few seconds. With the prior art technology, air temperature can only be changed by a significantly smaller delta T, e.g., 5° C. (10° F.), such that the maximum cooling of the car seat in a 130° F. cabin would be to 120° F., making such systems generally ineffective on hot days or in hot climates.

In addition, the blower technology does not work well in the heating mode in cold days or cold climates because of the low delta T achieved in air to seat heating and accordingly it may be supplemented with resistive heating, which has to be installed in addition to the blower and duct work hardware by the seat manufacturer.

For seat manufacturers, the use of perforated leather or other upholstery is an added cost to the seat and limits the durability of the leather or other upholstery. Also when the occupant sits on the seat, the perforations covered by the user are blocked resulting in reduced cooling to the occupant. The prior art technology is also very costly per seat and is difficult to install. Heating and cooling systems in accordance with various embodiments using a large area flexible heat spreader with remote thermoelectric device can be installed easily like a seat heater.

A heating and cooling system in accordance with various embodiments, which uses a large format flexible thermally conductive sheet with thermoelectric devices to pump heat, is very strong and robust and can withstand repeated physical abuse. Yet, the thermally conductive sheet is flexible and can be repeatedly flexed without failing. In addition, the heating and cooling system can be scaled to very large sizes with generally no limits on its size. The system also has substantial cooling and heating capacity limited only by the heat pumping capacity of the thermoelectric modules.

Current flexible thermoelectric modules are designed so that the thermoelectric circuit is flexible. This design is not feasible in applications like car seating where a robust module is needed that can withstand repeated abuse and flexing because the individual elements, typically Bi2Te3 elements, used in thermoelectric modules are brittle and not very strong. Thermoelectric devices in accordance with one or more embodiments are not positioned in the seat cushion area, but instead are remotely located away from the seating area to insure that they do not affect the seating comfort or the durability of the seat cooling and heating system. The high thermal conductive sheet allows the thermoelectric devices to be remotely located, yet still provide effective cooling and heating to the seat cushion area.

The flexible thermally conductive sheet can comprise various materials including, e.g., polyimide, graphite, PGS graphite, carbon fiber, or more advanced materials such as graphene or carbon nanotubes or other high thermal conductivity material such as copper or aluminum mesh. High thermal conductivity insures good temperature uniformity across the seat. The high thermal conductivity sheet is placed in the seat cushion area with rigid thermoelectric devices connected to the thermally conductive sheet away from the seat cushion area to insure comfortable seating. The thermoelectric modules are attached to the conductive sheet at the edges of the seat or underneath the seat so they do not affect the comfort or durability of the seat and the cooling and heating system.

In accordance with one or more embodiments, the thermoelectric device may be a single device or may be arranged in a multi-device modular array. They can comprise nanostructured Bi2Te3 alloys with ZT>0.8 or similar low-temperature thermoelectric materials bonded to rigid ceramic substrates on the top and bottom with rigid copper bus layers for the thermoelectric circuit. High ZT (>1.0) nano-Bi2Te3 materials can improve the coefficient of performance (COP) of cooling and power efficiency. Other thermoelectric devices such as thin film thermoelectrics or other low temperature thermoelectric materials can also be utilized in this embodiment. In accordance with one or more embodiments, the submodules in the modular array can utilize a BCAM module structure, which eliminates shear stress from thermal cycling.

The thermoelectric device can be bonded to the thermally conductive sheet using a thermally conductive adhesive or a thermal interface material at a remote location away from the seating area.

The other side of the thermoelectric device is then attached to a heat rejection system, which can be, e.g., another thermally conductive sheet, a heat sink (with or without a fan), or a heat pipe with an attached heat sink (with or without a fan) for heat rejection of the heat pumped from the flexible thermally conductive sheet.

In accordance with one or more embodiments, an alternate heat rejection system can be a liquid based heat rejection system comprising a heat exchanger liquid thermal block, tubing and a liquid to air heat exchanger (which can be a liquid filled radiator with fins for heat rejection).

In accordance with one or more embodiments, as an option to one or more thermoelectrics in thermal parallel to the heat spreader, a plurality of thermoelectric devices are stacked in thermal series in a cascade configuration to increase delta T for very hot and very cold climates. The thermoelectric devices can be stacked since they are remotely located from the seating area and will not affect seating comfort. For instance, a double stack of thermoelectric devices or cascade may be used in place of a single thermoelectric device layer to increase the operating maximum of the delta T of the thermoelectric stack, allowing the flexible conductive sheet to reach lower temperatures in high temperature ambient conditions. In the heating mode, the flexible conductive sheet with the thermoelectric stack can reach higher temperatures in very cold ambient conditions.

In a cooling operation, the thermoelectric devices pump heat from the flexible thermally conductive sheet to the heat sink, heat pipe, or thermally conductive sheet, which rejects the heat. This provides cooling to the flexible thermally conductive sheet and by direct contact through the upholstery to the seat occupant. The polarity on the thermoelectric devices may be reversed in a heating operation to pump heat from the heat sink, heat pipe, or thermally conductive sheet to the flexible thermally conductive sheet under the seat cushion to provide heating to the seat occupant. The advanced nano-bulk Bi2Te3 (with ZT>1.0) materials provide the higher COP for high cooling efficiency of the flexible thermally conductive sheet system compared with the conventional Bi2Te3.

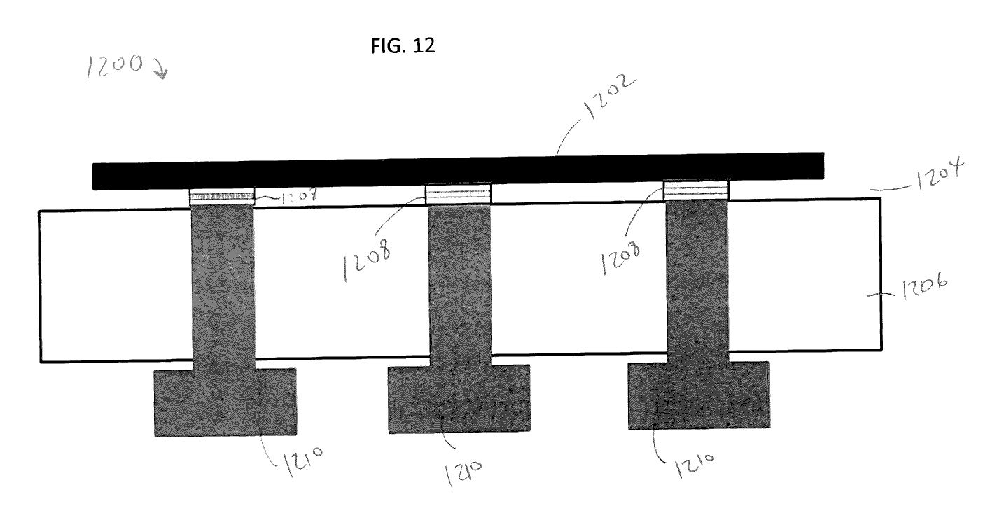

FIG. 12 is a cross-section view schematically illustrating an exemplary graphite foam block heat exchanger 1200 of a heating and cooling system in accordance with one or more embodiments. The foam block constitutes the heat rejection system and can be used with or without a fan and can replace the heat sink and fan described previously for a lighter weight heat rejection system. The heat exchanger 1200 includes a flexible graphite sheet 1202, low thermal conductive insulation 1204, on a bottom seat cushion 1206. Thermoelectric devices 1208 are positioned between the flexible graphite sheet and graphite foam elements 1210.

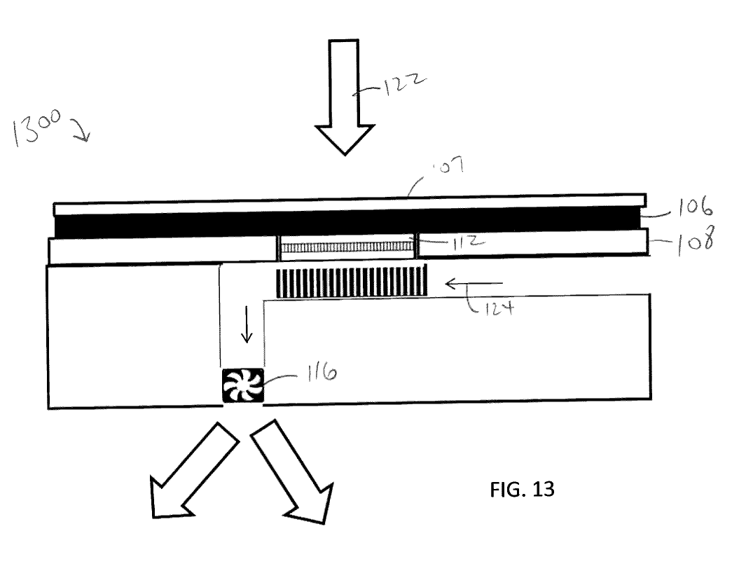

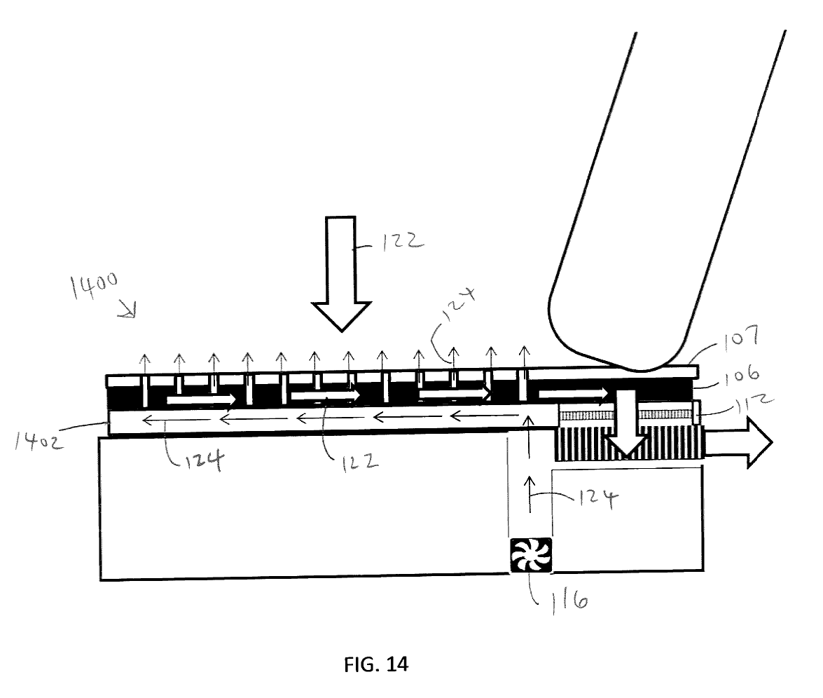

FIGS. 13 and 14 are cross-section views schematically illustrating further alternative car seat bottoms 1300 and 1400, respectively, including a heating and cooling system in accordance with one or more embodiments. FIG. 14 illustrates a single thermal electric device solution with additional convective and evaporative cooling. An air channel 1402 is provided for additional convective and evaporative cooling through holes in a heat spreader/upholstery.

In accordance with one or more embodiments, the thermally conductive sheet system is combined with a blower system to provide additional cooling to the occupant. A hybrid thermally conductive sheet system with blower system could be a luxury addition to the car seat cooler for increase cooling by combining direct contact cooling with convective and evaporative cooling. The system may include a blower or fan to blow air through holes in a heat spreader sheet to provide additional convective cooling or heating to the seat.

In accordance with one or more embodiments, the flexible thermally conductive sheet system can be fabricated easily using a graphite sheet or similar flexible conductive sheet.

In accordance with one or more embodiments, the flexible thermally conductive sheet system can be fabricated easily by laminating several thin PGS graphite sheets or similar flexible conductive sheets (that are only available in thin sheets) together using an adhesive that is thermally conducting.

In accordance with one or more embodiments, the flexible thermally conductive sheet can be a woven fibrous material, mesh, or composite material.

In accordance with one or more embodiments, the graphite or graphene sheets are reinforced with strengthening material to increase the robustness of the flexible graphite sheet.

In accordance with one or more embodiments, the flexible thermally conductive sheet varies in thickness to more evenly distribute cooling or heating to the user.

In accordance with one or more embodiments, the flexible thermally conductive sheet includes slices therein to direct cooling or heating to the user.

In accordance with one or more embodiments, the flexible thermally conductive sheet comprises a stack of or lamination of thinner sheets to increase thermal heat flow capacity.

In accordance with one or more embodiments, the flexible thermally conductive sheet comprises upholstery for the seat. In one or more embodiments, the flexible thermally conductive sheet is positioned under thermally conductive upholstery for the seat.

In accordance with one or more embodiments, a heat spreader sheet is provided for spreading the cooling or heating effect of the thermoelectric device over a large area on the seat bottom and seat back in order to provide and maximize thermal comfort for the seat occupant.

The cost for the large format flexible thermally conductive sheet system can be low because the flexible thermally conducting sheets like graphite are relatively inexpensive and the thermoelectric modules can be produced in volume using automated semiconductor processing tools for low cost.

In accordance with one or more embodiments, the thermoelectric modules are optionally fabricated using advanced low temperature materials such as nano-Bi2Te3 with high COP. The advanced nano-Bi2Te3 material for the thermoelectric modules can be manufactured using advanced powder processing including cryo-milling and hot pressing techniques using high pressures.

In accordance with one or more embodiments, the temperature of the thermally conductive sheet can be automatically controlled using a temperature sensor connected to the thermally conductive sheet and a temperature feedback loop circuit connected to the thermoelectric device(s). The temperature feedback loop circuit includes a power controller to provide temperature control of the seat both in the cooling and heating modes to maintain a seat temperature set by the seat occupant. Once the temperature is set, the power controller maintains the temperature of the seat at the set value. This allows the occupant to control the temperature of the seat to their comfort level so the seat does not feel too hot or cold.

In accordance with one or more embodiments, the temperature of the thermally conductive sheet can be remotely controlled using a variable power supply such as a pulse width modulation supply so the occupant can control the amount of heat pumping by the thermoelectric device thus controlling the temperature. This allows the occupant to control the temperature of the seat to their comfort level to achieve maximum thermal comfort and so the seat does not feel too hot or cold.

A delay circuit can be used to keep the polarity change from damaging the thermoelectric devices.

Also, the heating and cooling system can be remotely and wirelessly activated to cool or heat the seats before the occupant enters the vehicle.

The large format flexible thermally conductive sheet with remote thermoelectric modules can be used in both the seat bottom and seat back with a temperature feedback loop to a power controller

In addition to vehicle seats, heating or cooling systems described herein can be used in a variety of other user items such as, e.g., an office chair, bed, a cooling vest and other apparel to provide efficient heating or cooling of the user or occupant. The large format flexible thermally conductive sheet can also be used as a cooling or heating pad, e.g., for hospitals or other medical use, and also for cooling or heating food, e.g., in buffet tables or picnic coolers.

The large format flexible thermally conductive sheet is also suited for other applications such as heat to power conversion applications. The large format flexible thermally conductive sheet can also be used for large area electronics cooling where a large amount of heat has to be pumped efficiently over a large area.

Having thus described several illustrative embodiments, it is to be appreciated that various alterations, modifications, and improvements will readily occur to those skilled in the art. Such alterations, modifications, and improvements are intended to form a part of this disclosure, and are intended to be within the spirit and scope of this disclosure. While some examples presented herein involve specific combinations of functions or structural elements, it should be understood that those functions and elements may be combined in other ways according to the present disclosure to accomplish the same or different objectives. In particular, acts, elements, and features discussed in connection with one embodiment are not intended to be excluded from similar or other roles in other embodiments.

Additionally, elements and components described herein may be further divided into additional components or joined together to form fewer components for performing the same functions.

Accordingly, the foregoing description and attached drawings are by way of example only, and are not intended to be limiting.

1. A device, comprising:
an article for use by a user; and
a heating and/or cooling system arranged with the article to heat and/or cool the user, said heating and/or cooling system comprising:
a flexible thermally conductive sheet positioned in the article to be proximate to the user;
one or more thermoelectric modules or heat pumps in thermal contact with the flexible thermally conductive sheet; and
a heat rejection system in thermal contact with the one or more thermoelectric modules or heat pumps;
wherein the one or more thermoelectric modules or heat pumps can be powered to pump heat from the flexible thermally conductive sheet to the heat rejection system in a cooling mode and/or pump heat from the heat rejection system to the flexible thermally conductive sheet in a heating mode.

2. The device of claim 1, wherein the flexible thermally conductive sheet has thermal conductivity greater than 100 W/m-K.

3. The device of claim 1, wherein the article comprises a seat having a seat bottom and a seat back adapted to support a seated user, and wherein the heating and/or cooling system is disposed in the seat bottom and/or the seat back such that the flexible thermally conductive sheet is proximate to the seated user.

4. The device of claim 3, wherein the one or more thermoelectric modules is positioned in the seat at a location remote from a seating area of the seat.

5. The device of claim 1, wherein the article comprises a seat having a thermally insulating seat cushion or a thermal insulating layer on a seat cushion covered by upholstery, and wherein the flexible thermally conductive sheet is positioned between the upholstery and the thermally insulating seat cushion or the thermal insulating layer on the seat cushion.

6. The device of claim 1, wherein the one or more thermoelectric modules comprises a low-temperature thermoelectric material.

7. The device of claim 6, wherein the low-temperature thermoelectric material comprises a nanostructured Bi2Te3 alloy with ZT>1.0.

8. The device of claim 1, wherein the flexible thermally conductive sheet comprises graphite, PGS graphite, carbon fiber, polyimide, carbon nanotube, graphene, copper, or aluminum.

9. The device of claim 1, wherein the flexible thermally conductive sheet system is fabricated by laminating a plurality of flexible conductive sheets together using a thermally conductive adhesive.

10. The device of claim 1, wherein the flexible thermally conductive sheet comprises woven fibrous material, mesh, or composite material.

11. The device of claim 1, wherein the flexible thermally conductive sheet varies in thickness to more evenly distribute cooling or heating to the user.

12. The device of claim 1, wherein the flexible thermally conductive sheet includes slices therein to direct cooling or heating to the user.

13. The device of claim 1, wherein the flexible thermally conductive sheet comprises a stack or lamination of thinner sheets to increase thermal heat flow capacity.

14. The device of claim 1, wherein the one or more thermoelectric modules are bonded or connected to the flexible thermally conductive sheet using a thermal adhesive or a thermal interface material.

15. The device of claim 1, wherein the one or more thermoelectric modules each comprise a single thermoelectric module, multiple thermoelectric modules, or a two or more-layer stack of thermoelectric modules for increased heating or cooling effect.

16. The device of claim 1, further comprising a fan or blower to increase heat dissipation in the heat rejection system in the cooling operation mode and to increase heat absorption in the heating mode.

17. The device of claim 1, wherein the article comprises a seat further comprising a heat spreader sheet for spreading the cooling or heating effect of the thermoelectric device over a large area on a seat bottom and seat back of the seat to enhance thermal comfort for the user.

18. The device of claim 1, wherein the system further comprises a blower or fan to blow air through holes in the heat spreader sheet to provide additional convective cooling or heating to the article.

19. The device of claim 1, wherein the system further comprises a thermoelectric power control system for controlling the temperature of the thermally conductive sheet including a temperature sensor connected to the thermally conductive sheet and a feedback loop to drive the thermoelectric power control system.

20. The device of claim 1, wherein the temperature of the thermally conductive sheet can be remotely controlled using a variable power supply so the user can control the amount of heat pumping by the thermoelectric device thereby controlling the temperature of the article.

21. The device of claim 20, wherein the control system can be remotely controlled to set and maintain a desired temperature of the article.

22. The device of claim 1, wherein the article comprises a seat, and wherein the flexible thermally conductive sheet comprises upholstery for the seat or wherein the flexible thermally conductive sheet is positioned under thermally conductive upholstery for the seat or between the upholstery and a seat cushion.

23. The device of claim 1, wherein the heat rejection system comprises a heat sink or heat exchanger or a heat sink or heat exchanger with heat pipes.

24. The device of claim 1, wherein the heat rejection system is a liquid based heat rejection system comprising a heat exchanger liquid thermal block with a thermal interface to the thermoelectric module, tubing, and a liquid to air heat exchanger.

25. The device of claim 1, wherein the article comprises a vehicle seat, a chair, bed or a sofa.

26. The device of claim 1, wherein the article comprises apparel, a bed topper, a seat topper, a medical pad, or a heating/cooling pad.
